(19) United States
(12) Patent Application Publication
(10) Pub. No.: US 2010/0223653 A1
(43) Pub. Date: Sep. 2, 2010

(54) DIGITAL VIDEO BROADCAST RECEIVER AND METHOD FOR RECEIVING DIGITAL VIDEO BROADCAST DATA

(76) Inventors: Arie G. C. Koppelaar, Giessen (NL); Onno Eerenberg, Oisterwy (NL); Armand M. Stuivenwold, Wijchen (NL)

Correspondence Address: Munck Carter, LLP;Docket Clerk, P.O. BOX 802432, Dallas, TX, 75380, US

(21) Appl. No.: 12/733,190

(22) PCT Filed: Aug. 18, 2008
(86) PCT No.: PCT/IB2008/053300

§ 371 Date: May 11, 2010

(30) Foreign Application Priority Data
Aug. 16, 2007 (EP) 07114416.6

(51) Int. Cl. H04N 5/44

(52) U.S. Cl. 725/142

(57) ABSTRACT

A digital video broadcast receiver for receiving data of a plurality of services (S1-S3) which are transmitted in bursts of data over a transmission channel is provided. The receiver comprises a rendering unit (HH) for rendering data of a selected first service (S1) from the plurality of services (S1-S3). The receiver furthermore comprises at least one memory unit (FM, SC) for caching at least one received burst of data associated to the selected first service (S1) of the plurality of services (S1-S3). The memory is furthermore used for caching at least a first part of a received burst of data of at least a second service (S2) of the plurality of services (S1-S3). The receiver furthermore comprises an input unit (HH) for inputting a zap command to switch the rendering of the first service (S1) to a second service (S2) of the plurality of services (S1-S3). The rendering unit (HH) is furthermore adapted to render at least the cached first part of the received burst of data of the second service (S2) when the zap command is received by the input unit (HH).

### FIELD OF THE INVENTION

The present invention relates to a digital video broadcast receiver as well as to a method for receiving digital video broadcast data.

### BACKGROUND OF THE INVENTION

The digital video broadcast handheld (DVB-H) is a new European Telecommunications Standards Institute ETSI standard for providing digital video broadcasting services to handheld devices like mobile phones. This standard has been described in “DVB-H Implementation Guidelines, ETSI TR102377, V1.2.1, November 2005”. This standard serves to implement digital video broadcasting services to mobile devices or handheld devices. As this standard is directed to mobile devices, it is important to provide implementations which allow a low power operation in a DVB receiver.

DVB-H is based on the DVB-T standard and it is designed to be fully backwards-compatible. However, DVB-H allows additional features in particular to support a mobile reception. Such features include power saving, mobility with high data rates, single antenna reception and SFN networks. Furthermore, DVB-H allows an impulsive noise tolerance, an increased general robustness as well as a support for seamless handover during power off-times. In the DVB-H, the information is broadcast in transport streams, wherein several MPEG-2 encoded programs are multiplexed. To enable a power saving in the DVB-H receiver, time-slicing is implemented. Multi-Protocol Encapsulation Forward Error Correction MPE-FEC is also included to improve the robustness of the system. In addition, a 4k mode is implemented for mobility and to improve the network design flexibility.

To improve the low-power implementation of a receiver, data is transmitted in bursts at a high rate such that the receiver can be switched off between subsequent bursts. This can lead to an energy saving of up to 90%.

FIG. 1 shows a representation of a time-sliced transmission of DVB data. Here, the transmission of four services S1, S2, S3 and S4 is depicted. As an example, only the first service S1 is required by the DVB receiver, i.e. the DVB receiver will only be switched on during the reception of the first service S1, i.e. during Tₒₙ while the DVB receiver will be switched off during the transmission of the second, third and fourth service S2-S4, i.e. during the period T_{off}. Accordingly, a power saving of T_{off}/(Tₒₙ+T_{off}) is achieved. Such a power saving can be up to 90% depending on the number of services which are transmitted. The actual power saving is determined by the average service bit rate and the overall transmission bit rate. During the time period Tₒₙ, DVB-H data is transmitted in a burst, wherein the transmission rate is sufficiently high to transmit sufficient data such that the data is rendered until the next data burst is received. Accordingly, during the time period Tₒₙ, the amount of data which is received must be sufficient to ensure a rendering of data during the time period T_{off}. In the data burst, preferably multi-protocol encapsulation MPE sections are transmitted which contain internet protocol IP datagrams. Thereafter, the multi-protocol encapsulation forward error correction MPE-FEC section is transmitted which may comprise RS parity columns.

The IP encapsulation is introduced into DVB to ensure a convergence between the so-called traditional broadcast world and the PC world. Therefore, IP encapsulation is combined with time slicing.

If a user wants to switch between the services S1-S4, a period of time will elapse before the data of the selected service is transmitted and can be rendered on the handheld device. This period of time is called the zap time. The zap time can be reduced e.g. by measures which are taken at the transmitter of the DVB-H data.

EP 1 509 043 A1 describes a method to change the transmission scheme of the DVB-H data. Here, each burst of data is sent twice thus reducing the available bandwidth by a factor of 2.

EP 1 703 657 A1 relates to an addition error correction mechanism which is implemented at the transmitter of the DVB-H data. Here, a dedicated zapping stream is provided in parallel to the data stream, wherein the zapping stream comprises information at a low data rate which can be temporarily used during the zap time.

However, these documents merely describe an improvement of the zap time by means of changes at the transmission side.

### SUMMARY OF THE INVENTION

It is an object of the invention to provide a method for receiving DVB data containing several services, wherein the zap time for changing among the services is reduced by measures taken at the receiving side.

This object is solved by a DVB receiver according to claim 1 and a method for receiving DVB-H data according to claim 3.

Therefore, a digital video broadcast receiver for receiving data of a plurality of services which are transmitted in bursts of data over a transmission channel is provided. The receiver comprises a rendering unit for rendering data of a selected first service from the plurality of services. The receiver furthermore comprises a memory for caching at least one received burst of data associated to the selected first service of the plurality of services. The memory is furthermore used for caching at least a first part of a received burst of data of at least a second service of the plurality of services. The receiver furthermore comprises an input unit for inputting a zap command to switch the rendering of the first service to a second service of the plurality of services. The rendering unit is furthermore adapted to render at least the cached first part of the received burst of data of the second service when the zap command is received by the input unit.

According to an aspect of the invention, the cached first part of the received burst of data corresponds to the last part of the application data in the received burst of data.

The invention also relates to a method for receiving digital video broadcast data of a plurality of services, which are transmitted of bursts of data over a transmission channel. Data of a selected first service from a plurality of services is rendered. At least one received burst of data associated to the selected first service of the plurality of services is cached. At least a first part of a received burst of data of at least a second service of the plurality of services is cached as well. A zap command to switch the rendering of the first service to a second service is received. The cached first part of the received burst of data of the second service is rendered when the zap command is received.

According to an aspect of the invention, the cached first part of the received part of received burst of data of the second service is rendered at a rate which is slower than real time.

The present invention relates to the idea to reduce the zap time by using extra data caching in the DVB receiver, i.e. on the receiver's side.

Further aspects of the invention are defined in the dependent claims.

### BRIEF DESCRIPTION OF THE DRAWINGS

Advantages and embodiments of the invention will now be described in more detail with reference to the Figure.

FIG. 1 shows a representation of a time-sliced transmission of DVB data,

FIG. 2 shows an illustration of a service reception and rendering of DVB-H data according to a first embodiment, and

FIG. 3 shows a schematic block diagram of a DVB receiver according to the first embodiment.

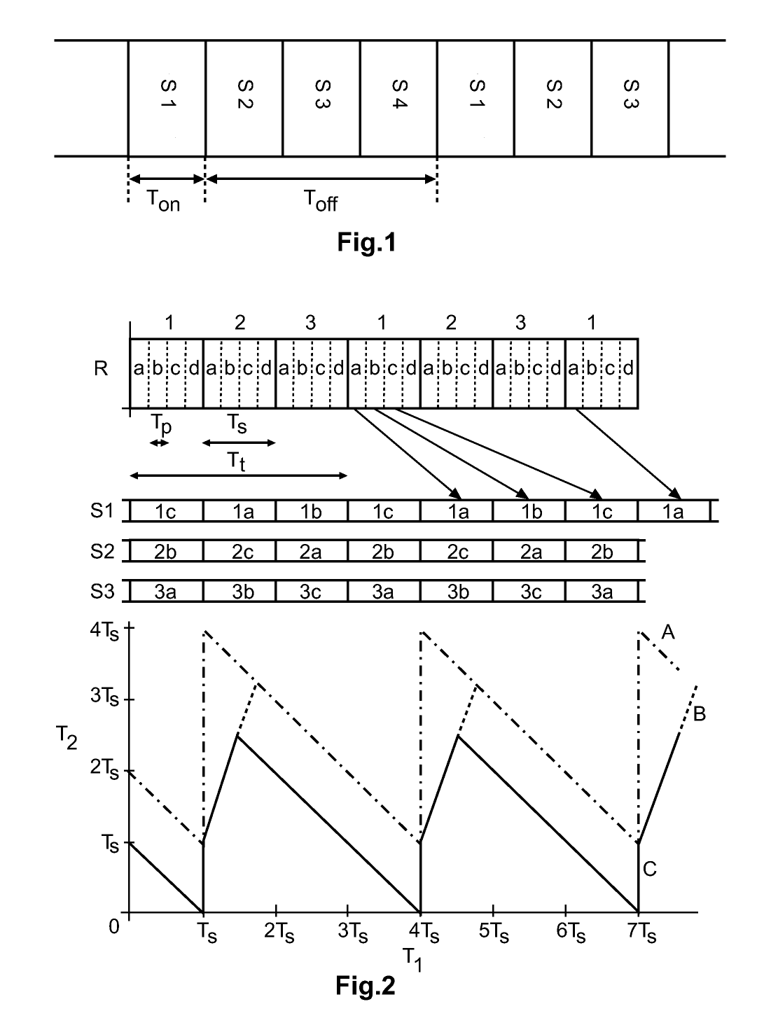

### DETAILED DESCRIPTION OF EMBODIMENTS

FIG. 2 shows an illustration of a service reception and rendering of DVB-H data according to a first embodiment. According to the first embodiment as not limiting example, three services S1-S3 are broadcasted. In the upper part of FIG. 2, the reception of the three services S1-S3 is depicted. In the middle part, the rendering of the three services S1-S3 is depicted. In the lower part of FIG. 2, a graph showing the relation between the zap time and the time of decision to zap is depicted. Each service may comprise application data a, b, c as well as parity data d. Each of these services can be coded with a R=¾ MPE-FEC code. The parity data d will therefore correspond to the MPE-FEC parity data and will correspond to ¼ of the burst while the application data a, b, c will correspond to ¾ of the burst as the application data in this example can be divided into three parts a, b, c.

It should be noted that the subdivision of the application date in a burst into three parts a, b and c is merely an illustrative example and refers to the so-called random access points RAP which are inserted to speed-up the zapping and which are used to confine the duration of an error. Other subdivisions are also possible. In case of video, it may refer to the so-called I-frames which are anchor frames or reference frames to the P- and B-frames. In other words, without an I-frame no P- and B-frames can be decoded. The relative number of the I-frames is a trade-off between the bit rate and the robustness of the signal.

It should be noted that each application data should start with a random access point RAP. The number of parts in which the application data of a burst can be divided will dependent on the number of random access points RAP.

The transmission of a burst will correspond to a time period Tₛ. The transmission of one of the four parts of a burst will correspond to the time period Tₚ, i.e. Tₛ=4*Tₚ. The time period Tₜ corresponds to the repetition time or repetition period of the service bursts S1-S3, i.e. Tₜ=3*Tₛ.

If the application data in each burst is divided by the number of services which are broadcasted, here three, one of the parts of the burst can be rendered while a further burst is transmitted and received, i.e. the time for rendering a part of the burst corresponds to the transmission/receiving time of a burst. Accordingly, if the first service S1 has been selected, then the parts a, b and c can be rendered during the transmission/reception of the bursts 2, 3 and 1, respectively. The rendering may also be performed at a lower rate. As the fourth part d of the burst merely comprises parity data, this part is not rendered.

In the following, different methods for selecting or changing to a further service, i.e. zapping from one service to a second service, are described in more detail.

Here, it is assumed for illustrative purposes that a user wants to switch from service S1 to service S2.

This can for example be performed by a scheme A, wherein the whole burst is received and rendered. In FIG. 2, the function A of the wait time T₂ until which the second service can be rendered with respect to the decision time T₁ to zap to the second service S2 is depicted. If the decision to zap to the second service S₂ occurs before a time interval Tₛ after the reception of a burst of data of the first service S₁, the zap time will be minimal (Tₛ) as the burst of data of the second service S₂ is received at the time interval Tₛ. However, if the user decides after the time interval Tₛ, it can take up to 4×Tₛ and the receiver has to wait until the next burst of the second service S₂ is received. In such a case the zap time will be maximal. As mentioned above in this case, the minimal possible zap time will correspond to the burst duration Tₛ, for the case that a user decides to switch to the second service S₂ before the burst of data of the second service has been received. It should be noted that as the whole burst has to be received, a MPE-FEC decoding has to be performed and the data has to be parsed to the application engine. Merely for illustrative purpose, it is assumed that the time required for processing and parsing the application data is zero. The maximum zap time will correspond to Tₛ+Tₜ as the user has to wait until the next burst starts which corresponds to the burst repetition time Tₜ. Here, Tₜ corresponds to 3×Tₛ, i.e. the maximum zap time corresponds to 4Tₛ, while the average zap time corresponds to 2.5Tₛ.

According to a second scheme B, only part of the burst is processed. The function B of the second scheme B is also depicted in FIG. 2. Therefore, parts of a buffer can be received and rendered. This will allow a reduction of the zap time for the case that the user decided to zap to the second service S₂ just after the burst of data for the second service S2 has been received. Accordingly, the maximum zap time will correspond to the time prior to the reception of the parity data of the burst of the second service. The average zap time will correspond to 2.125 Tₛ. According to the second scheme B, partial received burst data is rendered. It should be noted that the partially received burst data has to be synchronized with the rendering of the complete received burst to avoid a gap in the rendering of data. However, the zap time as perceived by the user can be reduced if the rendering of a partially received burst is started before the complete burst of data is received. However, the rendering of the partial received burst data can be performed at a lower rate. It should be noted that the rendering of a partial received burst can be postponed such that it will be synchronized with the rendering of the next completely received burst. Accordingly, gaps in the rendering of a service can be avoided. The postponing of the rendering of a partial received burst can be diminished if the data of partial received burst is rendered at a lower rate. The rendering of the partially received burst can also be used independently to reduce the zap-time.

According to a third scheme C which is considered as the first embodiment, parts of the burst of those services which are not rendered at the moment are cached. The function C of the third scheme is also depicted in FIG. 2. Here, the first service S1 is rendered on the handheld device of the user. The receiver is able to cache at least part of the application data of the services which are transmitted. In other words, one part of each of the burst data of the services is always received and cached. According to the first embodiment, the maximum zap time will correspond to 2.5 Tₛ and the average zap time will correspond to 4/3 Tₛ. On the other hand, the minimum zap time can be reduced to zero.

The perceptual zap time can further be reduced if the rendering of at least partially received bursts is started earlier and at a lower rate.

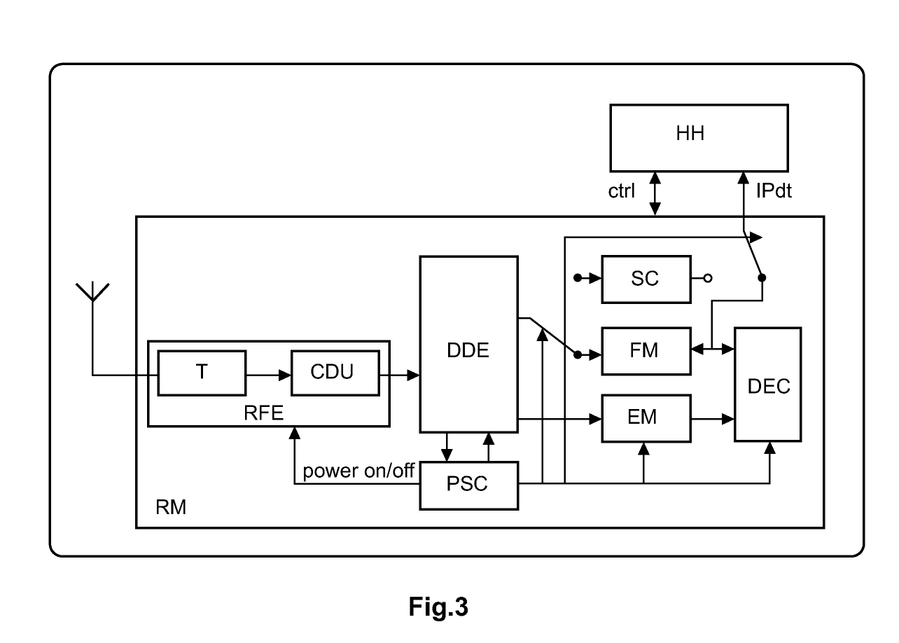

FIG. 3 shows a schematic block diagram of a DVB receiver according to the first embodiment. The DVB receiver RM comprises a receiver front-end RFE with a tuner T and a DVB-H/T channel demodulator CDU. The DVB receiver furthermore comprises a DVB-H-TS de-multiplexer and an IP-De-encapsulator DDE, a service cache SC, a MPE-FEC frame memory FM, an erasure memory EM and a MPE-FEC decoder DEC. The receiver module RM may furthermore comprise a power save control PSC. The receiver module can be coupled to a hand-held by a control terminal ctrl and an output terminal IPdt for forwarding IP data to the hand-held HH, which renders the IP data.

The tuner T serves to select the wanted RF signal and demodulates the received signal to an analogue baseband signal. The channel demodulator CDU digitizes the baseband signal, applies a digital demodulation and a first and second layer forward error correction FEC and delivers a transport stream TS. The DVB-H transport stream De-multiplexer and the internet protocol IP-De-encapsulator filters TS packets with the wanted TS packet identifier PID and extracts the application data IP datagram and the parity data (for the third layer FEC). The MPE-FEC frame memory FM is used to store application data and parity data of completely processed data (e.g. for the first service S1). Data for easing or improving the third layer FEC, i.e. the MPE-FEC is stored in the erasure memory EM. Application data of partial processed bursts (e.g. data from the second service S2) can be stored in the service cache SC. The MPE-FEC decoder applies the third layer FEC on the completely received burst of data. The power save control PSC extracts timing information relating to the start time of the burst and the burst duration. This may be done for the currently chosen service as well as for potentially wanted services. The power save control PSC may switch the receiver front-end RFE on and off at the appropriate times, i.e. when no burst is to be receiver to reduce the power dissipation. Furthermore, the power save control PSC may select whether the received data is written to the service cache SC (e.g. data from the second service S2) or to the MPE-FEC frame memory FM (e.g. data from the second service S2). It may further select whether application data is rendered from the MPE-FEC frame memory as a default or from the service cache during zap time.

According to the first embodiment, the maximum zap time can be reduced by 37.5% and the average zap time can be reduced by 46.7%. Therefore, the zap time can be significantly reduced. The data caching requirements are available such that a trade off between the cache memory and the zap time can be performed, wherein it is also possible that all received data is cached. The number of services which are transmitted and received is scalable.

However, on the other hand, additional data cache memory is required. The power consumption will be increased as the receiver will have to cache data during the off-time of the first service. Moreover, if partial burst reception is applied, the corresponding multi protocol encapsulation forward error correction has to be omitted. In other words, the data of a partial received burst is more vulnerable to errors than the data of a completely received and processed burst.

According to a further aspect of the invention, the perceived zap time can be decreased if data is rendered at a lower rate.

According to a further aspect, a MPE-FEC decoding is performed on all bursts of the received services while only a part of the application data of the bursts is cached. This can lead to a more robust cached data.

According to a further aspect of the invention, cache data does not need to be stored until the next burst is received. After a specific moment the cache data will not be rendered anymore. Therefore, the memory occupied by this cache data can be released before caching data of other services.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be constrained as limiting the scope of the claims.

1. Digital video broadcast receiver for receiving data of a plurality of services, which are transmitted in bursts of data over a transmission channel, comprising:
a rendering unit for rendering data of a selected first service from the plurality of services;
at least one memory unit for caching at least one received burst of data associated to the selected first service of the plurality of services and for caching at least a first part of a received burst of data of at least a second service of the plurality of services;
and an input unit for inputting a zap command to switch the rendering of the first service to a second service of the plurality of services; wherein the rendering unit is adapted to render at least the cached first part of the received burst of data of the second service when a zap command is received by the input unit.

2. Digital video broadcast receiver according to claim 1, wherein the cached first part of the received burst of data corresponds to the last part of application data in the received burst of data.

3. Method for receiving digital video broadcast data of a plurality of services, which are transmitted in bursts of data over a transmission channel, comprising the steps of:
rendering data of a selected first service from the plurality of services;
caching at least one received burst of data associated the selected first service of the plurality of services;
caching at least a first part of a received burst of data of at least a second service of the plurality of services;
receiving a zap command to switch the rendering of the first service to a second service of the plurality of services; wherein the cached first part of the received burst of data of the second service is rendered when a zap command is received.

4. Method for receiving digital video broadcast data according to claim 3, wherein the cached first part of the received part of the received burst of data of the second service is rendered at a rate which is slower than real time.
